(19) United States
(12) Patent Application Publication
(10) Pub. No.: US 2007/0229286 A1
(43) Pub. Date: Oct. 4, 2007

(54) Fall-over alert device

(76) Inventor: Dennis Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/490,187

(22) Filed: Jul. 21, 2006

(30) Foreign Application Priority Data
Mar. 31, 2006 (TW) 095111484

(51) Int. Cl. G08B 23/00; G08B 21/00

(52) U.S. Cl. 340/573.1; 340/686.1

(57) ABSTRACT

A fall-over alert device includes a transceiver, a detecting unit, and a CPU. When the detecting unit detects an abnormal condition from the fall-over alert, the CPU outputs a rescue request signal having an identification code via the transceiver. When a user accidentally falls over or falls unconsciously, the fall-over alert device sends out a rescue request signal with the identification code via the transceiver for help.

### BACKGROUND OF THE INVENTION

1. Field of the Invention

The present invention relates to a fall-over alert device, and more particularly, to an automatic emergency alert device for detecting whether a user is in danger.

2. Description of the Related Art

For most cases, elders have poor balance while walking or doing exercise, so they tend to fall more easily. In order to ensure their safe, a traditional emergency alert device including a transmitter and a receiver has been available. When an elder falls down, the transmitter sends out a rescue request signal to a corresponding receiving host to ask for help.

The traditional emergency alert system is used for lone worker protection, the transmitter sends out a rescue request signal to the corresponding receiving host and the receiving host asks for help from other personnel stand by. However, due to different transmitters cannot directly communicate with each other, such an alert system is very inconvenient in use, and moreover, this communication method might waste rescue time.

Therefore, it is desirable to provide an automatic emergency alert device for detecting whether the user is in danger so as to mitigate and/or obviate the aforementioned problems.

### SUMMARY OF THE INVENTION

A main objective of the present invention is to provide a fall-over alert device which can monitor a user's activity condition; if the user accidentally falls down or falls unconsciously, the fall-over alert device can send out a rescue request signal with an identification code to other fall-over alert devices or a base station so as to inform other staff members for emergency help.

The fall-over alert device according to the present invention comprises: a transceiver, a detecting unit, and a CPU. The CPU has an identification code; the transceiver is used for transmitting a rescue request signal with the identification code and receiving at lest one signal from at least one external device; the detecting unit is used for detecting the fall-over alert device; and the CPU is connected to the transceiver and the detecting unit.

In the fall-over alert device according to the present invention, when the detecting unit detects from the fall-over alert device an inclination angle which is greater than a predetermined value and exceeds a predetermined time, or detects the fall-over alert device maintaining still over a predetermined time period, or detects an inclination angle of the fall-over alert device greater than a predetermined value and that the fall-over alert device maintains still over a predetermined time period, the CPU outputs a rescue request signal with the identification code via the transceiver.

In the fall-over alert device according to the present invention, the CPU is connected to a displaying unit, when the transceiver receives the signal from the external device; the displaying unit displays a picture for identifying the source of the signal.

In the fall-over alert device according to the present invention, the CPU can be connected to a buzzer, when the detecting unit detects a great inclination angle from the fall-over alert device, the CPU turns on the buzzer to generate a warning sound. Furthermore, the CPU can also be connected to a vibration motor, when the detecting unit detects a great inclination anger from the fall-over alert device, the CPU turns on the vibration motor to generate a vibration warning. Moreover, the CPU can be connected to a lighting unit, when the detecting unit detects a great inclination angle from the fall-over alert device, the CPU turns on the lighting unit to generate a warning light.

The detecting unit of the fall-over alert device according to the present invention can be a horizontal detecting unit. The horizontal detecting unit detects whether the inclination angle of the fall-over alert device is greater than a predetermined value and over a predetermined time period. For example, a predetermined value of the inclination angle is set as 40° and a predetermined time period is set as 30 sec. When a user accidentally falls over or shocks, the inclination angle of the fall-over alert device according to the present invention is greater than the predetermined value 40°, and if after 30 sec, the fall-over device still has the inclination angle greater than 40°, an abnormal condition is determined. Then, the CPU automatically sends out a rescue request signal with the identification code via the transceiver.

The fall-over alert device further comprises a manual distress call unit for manual emergency alert. When the user thinks it's necessary (for example, feeling uncomfortable), he or she can press the manual distress call unit, and the CPU sent the rescue request signal with the identification code via the transceiver for help.

The detecting unit of the fall-over alert device according to the present invention may also be a motion sensing unit, the motion sensing unit detects whether the fall-over alert device is holding still over a predetermined time period. For example, if the user falls asleep which causes the fall-over alert device held still over a predetermined time, an abnormal condition is determined by the CPU, which then sends out the rescue request signal with the identification code via the transceiver.

For the fall-over alert device according to the present invention, the external device may be another fall-over alert device, another base station, or even a plurality of fall-over alert devices each of which has its own identification code. The base station of the present invention further comprises a manual distress call unit for controlling the base station to send the rescue request signal with the identification code to the other fall-over alert devices of the same group.

The fall-over alert device of the present invention can be used for mutual communication in a specific group, for example, a fire fighter team, a mountain climber team or a traveler team. Furthermore, the fall-over alert device also can communicate with the base station for emergency rescue, for example, for elders in a nursing home or hospital through detecting any occurrence of fall over.

Other objects, advantages, and novel features of the invention will become more apparent from the following detailed description when taken in conjunction with the accompanying drawings.

### BRIEF DESCRIPTION OF THE DRAWINGS

FIG. 1 is a system block diagram of a fall-over alert device according to the present invention.

FIG. 2 is a system block diagram of a base station according to the present invention.

FIG. 3 is a schematic view of an embodiment of the present invention.

### DETAILED DESCRIPTION OF THE PREFERRED EMBODIMENT

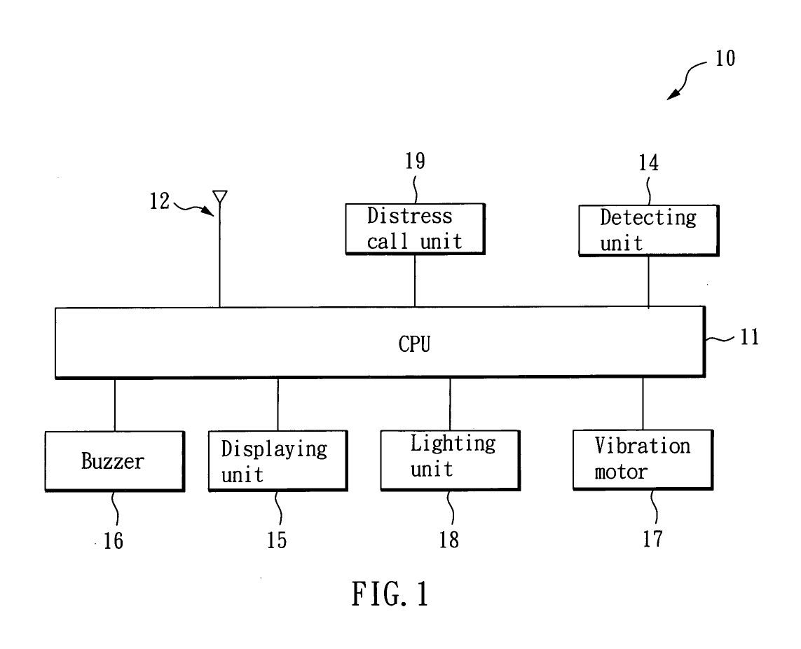

Referring to FIG. 1, a system block diagram of a fall-over alert device according to the present invention, where the fall-over alert device 10 comprises a CPU 11, a transceiver 12, a manual distress call unit 19 and a detecting unit 14. The CPU 11 has an identification code for the fall-over alert device 10. The transceiver 12 is used for transmitting a rescue request signal with the identification code and for receiving one or several signals from one or several external devices (not shown). The detecting unit 14 is used for detecting whether the fall-over alert device 10 has an abnormal condition.

The detecting unit 14 of the fall-over alert device according to the present invention can be a horizontal detecting unit, a motion detecting unit, or a horizontal and motion detecting unit. The horizontal detecting unit can detect whether the inclination angle of the fall-over alert device is greater than a predetermined value and stays over a predetermined time. The motion detecting unit can detect whether the fall-over alert device has been held still over a predetermined time.

Determining whether the fall-over alert device 10 has an abnormal condition is based on the detection result from the detecting unit 14, namely, (1) whether the inclination angle of the fall-over alert device 10 is greater than a predetermined value over a predetermined time period; or (2) whether the fall-over alert device 10 has been held still over a predetermined time period; or (3) whether the inclination angle of the fall-over alert device 10 is greater than a predetermined value and that the fall-over alert device 10 has been held still over a predetermined time period. When the fall-over alert device 10 has an abnormal condition, the CPU 11 automatically sends out a rescue request signal with the identification code via the transceiver 12.

Now referring to FIG. 1 again, the CPU 11 is connected to a displaying unit 15 when the transceiver 12 receives the signal from the external device, and that the displaying unit 15 displays a picture for identifying the source of the signal. The CPU 11 can also be connected to a buzzer 16, so that when the detecting unit 14 detects a great inclination angle from the fall-over alert device 10, the CPU 11 turns on the buzzer 16 to generate a warning sound. The CPU 11 can also be connected to a vibration motor 17. In this embodiment, when the fall-over alert device sends out a rescue request signal, the vibration motor stops vibration so as to avoid motion from the detecting unit in detecting the vibration and to stop the rescue request signal.

The CPU can also be connected to a lighting unit 18. When the detecting unit 14 detects a great inclination angle from the fall-over alert device, the CPU turns on the lighting unit 18 to generate a warning light, especially in a dark environment. Furthermore, the fall-over alert device 10 also comprises a manual distress call unit 19 (such as a button) for manual emergency alert. So the user can press the manual distress call unit 19 and the CPU sends out a rescue request signal with the identification code via the transceiver 12. Therefore, the user can send out rescue request signals easily.

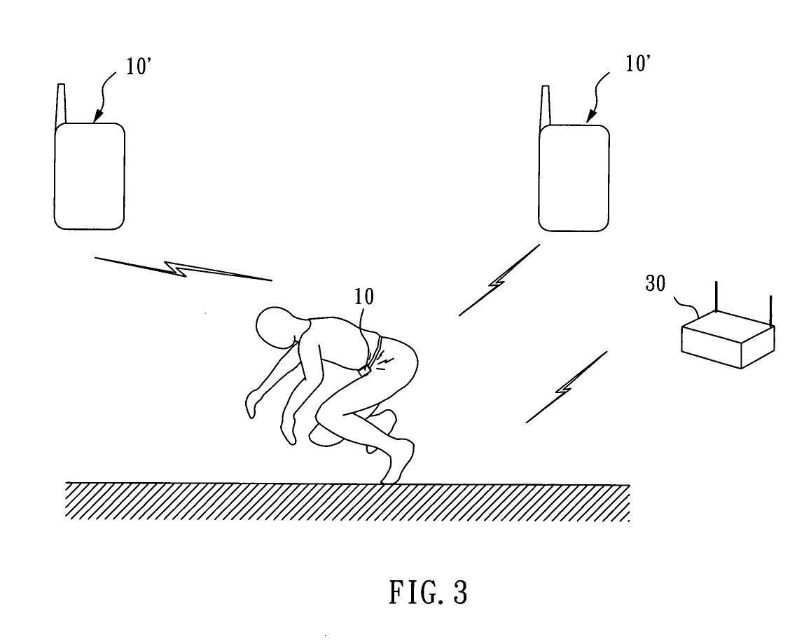

Referring to FIG. 3, a schematic view of an embodiment of the present invention, the fall-over alert device 10 can be carried on the user's waist, and can be incorporated with other fall-over alert devices 10′ and a base station 30 so as to form a group. The fall-over alert device 10 and the fall-over alert devices 10′, as shown in FIG. 3, are identical fall-over alert devices with different identification codes.

The rescue request signal sent by any fall-over alert device 10 in the group can be directly received by other fall-over alert device 10′ in the group, and the fall-over alert device 10′ receiving the rescue request signal can display on its displaying unit the identification code of the fall-over alert device 10 sending out the rescue request signal. Therefore, other users in the group can be alerted and identify each other.

Now referring to FIG. 1 and FIG. 3, when fire fighters wear fall-over alert devices 10 to enter a fire scene, the detecting unit 14 can detect whether the fall-over alert device 10 has any abnormal condition, for example, suppose the detecting unit 14 is a horizontal detecting unit which can detect an inclination angle and has a predetermined value of the inclination angle set as 40° and a predetermined time period of 30 sec. When a user (fire fighter) accidentally falls or shocks, the inclination angle of the fall-over alert device 10 is greater than the predetermined value 40°, and if after 30 sec, the fall-over alert device 10 still has the inclination angle greater than 40°, an abnormal condition is determined. Then, the CPU 11 automatically sends out the rescue request signal with the identification code via the transceiver 12. Therefore, other fall-over alert devices 10′ carried by other members or the base station 30 can all receive the rescue request signal.

The other fall-over alert devices 10′ can display on their displaying units 15 the identification code of the fall-over alert device 10 sending out the rescue request signal. So other staff members can identify the user whose fall-over alert device sending out the rescue request signal.

Furthermore, the fall-over alert device 10 can notify the location of the user via sound warning or light warning so as to help other members to find out the user whose fall-over alert device sending out the rescue request signal.

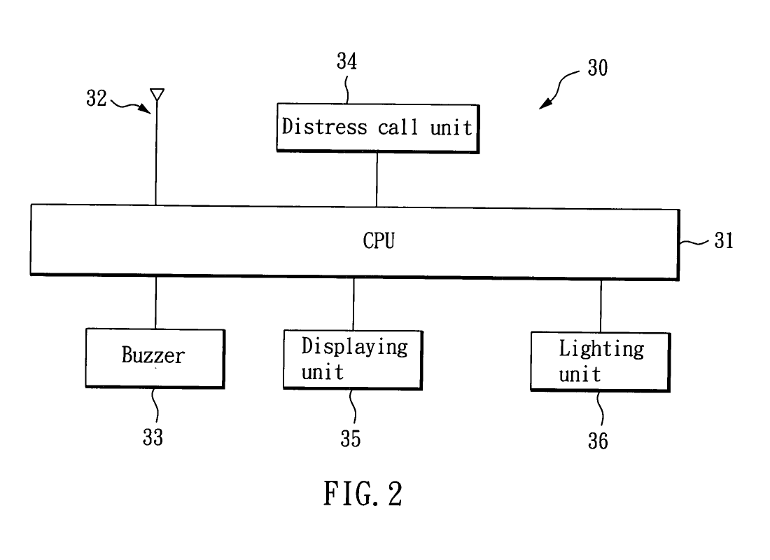

Referring to FIG. 2, a system block diagram of a base station according to the present invention, the base station 30 has a CPU 31, a transceiver 32, a buzzer 33, a manual distress call unit 34, a displaying unit 35 and a lighting unit 36. As shown in FIG. 3, the base station 30 can be set in a group relationship with each individual fall-over alert device 10 (or 10′), and the CPU 31 of the base station 30 can store a plurality of identification codes for group identification. The manual distress call unit 34 controls the base station 30 and sends out the rescue request signal with identification code (such as team number, nickname or name) to other fall-over alert devices 10. The rescue request signal sent from one of the fall-over alert devices 10 (or 10′) can be received by the base station 30 or other fall-over alert device 10′. The base station 30 displays on the displaying unit 35 the identification code of the fall-over alert device 10 sending the rescue request signal, and the buzzer 33 generates a buzz warning sound and the lighting unit 36 is turned on for a warning light. Other associated staff members can know which user is in danger according to the displaying unit 35 and thus provide help.

According to the above-mentioned description, the fall-over alert device and the fall-over alert system have a communication function with each other in the group, and every fall-over alert device can send out a rescue request signal to other fall-over alert device and the base station in the group. Since every fall-over alert device has an identification code, when the fall-over alert device receives a rescue request signal sent by any of the fall-over alert devices in the group, it directly displays on the displaying unit the identification code of the fall-over alert device sending out the signal. With the identification code, the fire fighters or medical staff members can quickly identify the user in danger. Furthermore, the base station can also send out signal to any member of the group to provide help.

Although the present invention has been explained in relation to its preferred embodiment, it is to be understood that many other possible modifications and variations can be made without departing from the spirit and scope of the invention as hereinafter claimed.

What is claimed is:

1. A fall-over alert device comprising:
a transceiver for transmitting a rescue request signal having an identification code and for receiving at lest one signal from at least one external device;
a detecting unit for detecting whether the fall-over alert device is in an abnormal condition; and
a CPU having the identification code, and the CPU being connected to the transceiver and the detecting unit;
when the detecting unit detects an inclination angle of the fall-over alert device greater than a predetermined value and exceeding a predetermined time, or detects the fall-over alert device maintaining still over a predetermined time period, or detects an inclination angle of the fall-over alert device greater than a predetermined value and exceeding a predetermined time period and the fall-over alert device maintaining still over a predetermined time period, the CPU outputs a rescue request signal with the identification code via the transceiver.

2. The fall-over alert device as claimed in claim 1, wherein the CPU is connected to a displaying unit, when the transceiver receives the signal from the external device, the displaying unit displays a picture for identifying the source of the signal.

3. The fall-over alert device as claimed in claim 1, wherein the CPU is connected to a buzzer, when the detecting unit detects an abnormal condition from the fall-over alert device, the CPU turns on the buzzer to generate a warning sound.

4. The fall-over alert device as claimed in claim 1, wherein the CPU is connected to a vibration motor, when the detecting unit detects an abnormal condition from the fall-over alert device, the CPU turns on the vibration motor to generate a warning vibration.

5. The fall-over alert device as claimed in claim 1, wherein the CPU is connected to a lighting unit, when the detecting unit detects an abnormal condition from the fall-over alert device, the CPU turns on the lighting unit to generate a warning light.

6. The fall-over alert device as claimed in claim 1, wherein the detecting unit is a horizontal detecting unit which detects whether the inclination angle of the fall-over alert device is greater than a predetermined value over a predetermined time period.

7. The fall-over alert device as claimed in claim 1, wherein the detecting unit is a motion sensing unit which detects whether the fall-over alert device is held still over a predetermined time period.

8. The fall-over alert device as claimed in claim 1, wherein the predetermined value of the inclination angle of the fall-over alert device is 40°.

9. The fall-over alert device as claimed in claim 1, wherein the external device is another fall-over alert device.

10. The fall-over alert device as claimed in claim 1, wherein the external device is a base station, which can either transmit signals to the fall-over, alert device or receives the rescue request signal with the identification code from the fall-over alert device.

11. The fall-over alert device as claimed in claim 1, wherein the external device is a plurality of fall-over alert devices each of which has a different identification code.

12. The fall-over alert device as claimed in claim 1, further comprising a manual distress call unit for manual emergency alert.
